(19) United States
(12) Patent Application Publication
(10) Pub. No.: US 2026/0359215 A1
(43) Pub. Date: Nov. 12, 2026

(54) SYSTEMS AND METHODS FOR SETTING SOLID STATE INDIRECTION UNIT SIZE ON A PER NAMESPACE BASIS

(71) Applicant: Dell Products L.P., Round Rock, TX (US)

(72) Inventors: Kurtis W. DORSEY, New Braunfels, TX (US); Jeffrey J. DEMOSS, Austin, TX (US); Ricardo V. DOMINGUEZ, Georgetown, TX (US); Gregory M. ALLEN, Layton, UT (US)

(73) Assignee: Dell Products L.P., Round Rock, TX (US)

(21) Appl. No.: 19/199,847

(22) Filed: May 6, 2025

(51) Int. Cl. G06F 12/02

(52) U.S. Cl. CPC G06F 12/0246; G06F 2212/7202

(57) ABSTRACT

An information handling system may include a processor, a storage resource communicatively coupled to the processor and comprising storage media and a memory, and logic configured to create one or more independently configurably-sized namespaces within the storage media and for each namespace of the one or more independently configurably-sized namespaces, create within the memory a respective translation table having references to blocks stored on such namespace, wherein a block size of the blocks referenced by the references are independently configurable on a per-translation table basis.

### TECHNICAL FIELD

The present disclosure relates in general to information handling systems, and more particularly to systems and methods for maximizing performance of solid state drives in an information handling system by setting sizes of indirection units in a solid state drive on a per-namespace basis.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Solid state drives (SSDs) are often used as storage devices within information handling systems. As capacities of SSDs have grown, the amount of dynamic random access memory (DRAM) that can physically be placed on a small form factor SSD (e.g., Enterprise and Datacenter SSD Form Factor (EDSFF) and U.2 SSD form factors) is very limited and expensive. Accordingly, larger capacity drives (e.g., 30 TB and greater) often require an increase to the size of their indirection units as well. Many SSDs below 30 TB in capacity often utilize a 4 KB indirection unit size, which means that each entry into the flash translation layer of the SSD points to 4 KB of data.

If an input/output operation written to the SSD is smaller than the size of the indirection unit, then a read-modify-write operation within the SSD will need to be performed to write in indirection unit-sized blocks. Because most modern operating systems work on a 4 KB page size, these read-modify-write operations are typically not an issue.

However, as capacities of SSDs increase, the limited DRAM sizes may require sizes of indirection units to increase to much larger sizes (e.g., 8 KB and beyond). In the case of a 32 KB indirection unit, a 4 KB write operation would require the back end logic of an SSD to write 32 KB rather than 4 KB, causing a read-modify-write operation which would reduce input/output operations per second by a factor of 8, as well as increasing write amplification as well.

### SUMMARY

In accordance with the teachings of the present disclosure, the disadvantages and problems associated with existing solid state drives may be reduced or eliminated.

In accordance with embodiments of the present disclosure, an information handling system may include a processor, a storage resource communicatively coupled to the processor and comprising storage media and a memory, and logic configured to create one or more independently configurably-sized namespaces within the storage media and for each namespace of the one or more independently configurably-sized namespaces, create within the memory a respective translation table having references to blocks stored on such namespace, wherein a block size of the blocks referenced by the references are independently configurable on a per-translation table basis.

In accordance with these and other embodiments of the present disclosure, a method may include, in an information handling system comprising a storage resource having storage media and a memory, creating one or more independently configurably-sized namespaces within the storage media and for each namespace of the one or more independently configurably-sized namespaces, creating within the memory a respective translation table having references to blocks stored on such namespace, wherein a block size of the blocks referenced by the references are independently configurable on a per-translation table basis.

In accordance with these and other embodiments of the present disclosure, an article of manufacture may include a non-transitory computer readable medium and computer-executable instructions carried on the computer readable medium, the instructions readable by a processor, the instructions, when read and executed, for causing the processor to, in an information handling system comprising a storage resource having storage media and a memory, create one or more independently configurably-sized namespaces within the storage media and for each namespace of the one or more independently configurably-sized namespaces, create within the memory a respective translation table having references to blocks stored on such namespace, wherein a block size of the blocks referenced by the references are independently configurable on a per-translation table basis.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates a block diagram of a storage resource, in accordance with embodiments of the present disclosure.

### DETAILED DESCRIPTION

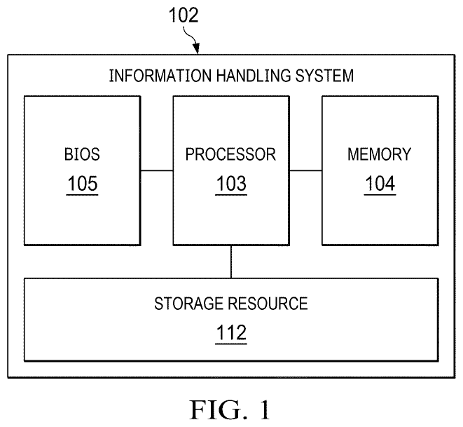

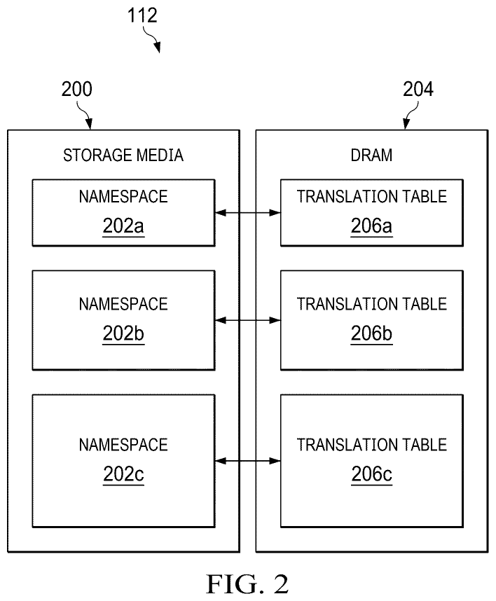

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input and output (“I/O”) devices, such as a keyboard, a mouse, and a video display. The information handling system may also include one or more buses operable to transmit communication between the various hardware components.

For the purposes of this disclosure, information handling resources may broadly refer to any component system, device or apparatus of an information handling system, including without limitation processors, buses, memories, input-output devices and/or interfaces, storage resources, network interfaces, motherboards, electro-mechanical devices (e.g., fans), displays, and power Supplies.

For the purposes of this disclosure, computer-readable media may include any instrumentality or aggregation of instrumentalities that may retain data and/or instructions for a period of time. Computer-readable media may include, without limitation, storage media such as a direct access storage device (e. g., a hard disk drive or floppy disk), a sequential access storage device (e.g., a tape disk drive), compact disk, CD-ROM, DVD, random access memory (“RAM”) , read-only memory (“ROM”), electrically erasable programmable read-only memory (“EEPROM”), and/or flash memory; as well as communications media such as wires, optical fibers, microwaves, radio waves, and other electromagnetic and/or optical carriers; and/or any combination of the foregoing.

Information handling systems often use an array of physical storage resources (e.g., disk drives), such as a Redundant Array of Independent Disks (“RAID”) , for example, for storing information. Arrays of physical storage resources typically utilize multiple disks to perform input and output operations and can be structured to provide redundancy which may increase fault tolerance. Other advantages of arrays of physical storage resources may be increased data integrity, throughput and/or capacity. In operation, one or more physical storage resources disposed in an array of physical storage resources may appear to an operating system as a single logical storage unit or “logical unit.” Implementations of physical storage resource arrays can range from a few physical storage resources disposed in a chassis, to hundreds of physical storage resources disposed in one or more separate storage enclosures.

FIG. 1 illustrates a block diagram of an example information handling system 102, in accordance with embodiments of the present disclosure. In some embodiments, information handling system 102 may comprise a server. In these and other embodiments, information handling system 102 may comprise a personal computer. In other embodiments, information handling system 102 may be a portable computing device (e.g., a laptop, notebook, tablet, handheld, smart phone, personal digital assistant, etc.). As depicted in FIG. 1, information handling system 102 may include a processor 103, a memory 104 communicatively coupled to processor 103, a BIOS 105 communicatively coupled to processor 103, and a storage resource 112 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, BIOS 105, storage resources 112, and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

BIOS 105 may be communicatively coupled to processor 103 and may include any system, device, or apparatus configured to identify, test, and/or initialize information handling resources of information handling system 102. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so s that one or more applications (e.g., an operating system or other application programs) stored on compatible media (e.g., memory 104) may be executed by processor 103 and given control of information handling system 102.

Storage resource 112 may be disposed in one or more storage enclosures configured to hold and power storage resource 112. Storage resource 112 may include hard disk drives, magnetic tape libraries, optical disk drives, magneto-optical disk drives, compact disk drives, compact disk arrays, disk array controllers, Non-Volatile Memory Express (NMVe) storage resources, and/or any other system, apparatus or device operable to store media. In particular embodiments, storage resource 112 may include a solid state drive.

In addition to processor 103, memory 104, BIOS 105, and storage resource 112, information handling system 102 may include one or more other information handling resources.

FIG. 2 illustrates a block diagram of a storage resource 112, in accordance with embodiments of the present disclosure. As shown in FIG. 2, storage resource 112 may include, among other components, storage media 200 (e.g., solid state storage) and DRAM 204. In operation, a user or administrator of information handling system 102 may be able to divide (e.g., with a setup utility executed by BIOS 105 or another component of information handling system 102) storage media 200 into one or more namespaces 202 (e.g., namespaces 202a, 202b, 202c). The size of each namespace 202 may be independently configurable by the user or administrator. Although FIG. 2 depicts three namespaces for purposes of clarity and exposition, a user or administrator may create any suitable number of namespaces 202 within storage media 200.

Further, when creating a namespace 202, the user or administrator may allocate a portion of DRAM 204 to a translation table 206 (e.g., a Flash Translation Lookup or “FTL” table) associated with such namespace 202. For example, as shown in FIG. 2, translation tables 206a, 206b, and 206c may be associated with namespaces 202a, 202b, and 202c, respectively.

Each translation table 206 may have a plurality of entries, each entry for translating a logical storage address to a physical storage address within the namespace 202 associated with such translation table 206. Thus, each entry within a translation table 206 may reference a block of data of a certain block size within its associated namespace 202. Further, on a per-translation table 206 basis, the block size referenced by entries of such translation table 206 may be independently configurable by the user or administrator. In other words, referring to FIG. 2, a user or administrator may:
configure translation table 206a such that each of its entries reference blocks of data stored on namespace 202 a of a first block size (e.g., 4 KB) ;
configure translation table 206b such that each of its entries reference blocks of data stored on namespace 202b of a second block size (e.g., 8 KB) ; and
configure translation table 206c such that each of its entries reference blocks of data stored on namespace 202 c of a third block size (e.g., 32 KB).

Accordingly, by independently configuring each translation table 206 to have their respective entries reference different block sizes, a user or administrator may thus have an ability to configure indirection unit sizes on a per-namespace 202 basis. For example, in the examples given in the bullet-point list above, indirection unit sizes for namespaces 202a, 202b, and 202c would be 4 KB, 8 KB, and 32 KB respectively. Thus, namespaces 202 may be optimized with differently-sized indirection units. For example, a namespace 202 optimized for small blocks may have small-sized (e.g., 4 KB) indirection units, a namespace 202 optimized for large block workloads and large capacity may have large-sized (e. g., 32 KB or 64 KB) indirection units, and namespaces 202 having medium-sized input/output and/or medium capacity may have medium-sized indirection units (e. g., 8 KB) with a size intermediate to the small-sized and large-sized indirection units.

To perform the foregoing functionality, storage resource 112 (e. g., via a drive controller integral to or otherwise associated with storage resource 112) may maintain a running table of the capacity of DRAM 204 required to maintain translation tables 206 for the currently-allocated namespaces 202. When storage resource 112 receives a request to create a new namespace 202, storage resource 112 may determine an amount of DRAM 204 required to allocate to such new namespace 202, depending on the size of such new namespace 202 and the requested indirection unit size for such new namespace 202. Storage resource 112 may compare a total capacity of DRAM 204 drive for translation tables 206 with a running total of memory used from DRAM 204, together with the new request. If there is insufficient memory to complete the request, storage resource 112 may report such insufficiency (e.g., to a host operating system executing on processor 103). Further, storage resource 112 may be configured to report (e.g., to a host operating system) an indication of total memory available and remaining within DRAM 204.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

1. An information handling system comprising:
a processor;
a storage resource communicatively coupled to the processor and comprising storage media and a memory; and
logic configured to:
create one or more independently configurably-sized namespaces within the storage media; and
for each namespace of the one or more independently configurably-sized namespaces, create within the memory a respective translation table having references to blocks stored on such namespace, wherein, for each respective translation table, the block size of the blocks referenced by the references is independently selected from a plurality of available block sizes at a time of creation of the namespace associated with such translation table and is independent of runtime activity state, zone state, and data temperature of regions within such namespace.

2. The information handling system of claim 1, wherein the storage media comprises a solid-state device.

3. The information handling system of claim 1, wherein the memory comprises dynamic random access memory.

4. The information handling system of claim 1, wherein the logic is integral to a setup utility of the information handling system.

5. The information handling system of claim 1, wherein the logic is integral to a basic input/output system of the information handling system.

6. The information handling system of claim 1, wherein the storage resource is configured to maintain a running table of a capacity of the memory required to maintain translation tables for allocated namespaces, and evaluate a request to create a new namespace by comparing DRAM capacity required to maintain a translation table for the new namespace against available memory capacity indicated by the running table.

7. A method comprising, in an information handling system comprising a storage resource having storage media and a memory:
creating one or more independently configurably-sized namespaces within the storage media; and
for each namespace of the one or more independently configurably-sized namespaces, creating within the memory a respective translation table having references to blocks stored on such namespace, wherein, for each respective translation table, the block size of the blocks referenced by the references is independently selected from a plurality of available block sizes at a time of creation of the namespace associated with such translation table and is independent of runtime activity state, zone state, and data temperature of regions within such namespace.

8. The method of claim 7, wherein the storage media comprises a solid-state device.

9. The method of claim 7, wherein the memory comprises dynamic random access memory.

10. The method of claim 7, wherein the steps of creating are performed by a setup utility of the information handling system.

11. The method of claim 7, wherein the steps of creating are performed by a basic input/output system of the information handling system.

12. The method of claim 7, further comprising maintaining, by the storage resource, a running table of a capacity of the memory required to maintain translation tables for allocated namespaces, and evaluating a request to create a new namespace by comparing DRAM capacity required to maintain a translation table for the new namespace against available memory capacity indicated by the running table.

13. An article of manufacture comprising:
a non-transitory computer readable medium; and
computer-executable instructions carried on the computer readable medium, the instructions readable by a processor, the instructions, when read and executed, for causing the processor to, in an information handling system comprising a storage resource having storage media and a memory:
create one or more independently configurably-sized namespaces within the storage media; and
for each namespace of the one or more independently configurably-sized namespaces, create within the memory a respective translation table having references to blocks stored on such namespace, wherein, for each respective translation table, the the block size of the blocks referenced by the references is independently selected from a plurality of available block sizes at a time of creation of the namespace associated with such translation table and is independent of runtime activity state, zone state, and data temperature of regions within such namespace.

14. The article of claim 13, wherein the storage media comprises a solid-state device.

15. The article of claim 13, wherein the memory comprises dynamic random access memory.

16. The article of claim 13, wherein the computer readable medium is integral to a setup utility of the information handling system.

17. The article of claim 13, wherein the computer readable medium is integral to a basic input/output system of the information handling system.

18. The article of claim 13, the instructions for further causing the storage resource to maintain a running table of a capacity of the memory required to maintain translation tables for allocated namespaces, and evaluate a request to create a new namespace by comparing DRAM capacity required to maintain a translation table for the new namespace against available memory capacity indicated by the running table.
